(19) United States
(12) Patent Application Publication
(10) Pub. No.: US 2018/0268004 A1
(43) Pub. Date: Sep. 20, 2018

(54) RULE HIERARCHIES FOR GRAPH ADAPTATION

(71) Applicant: Microsoft Technology Licensing, LLC, Redmond, WA (US)

(72) Inventors: Robert Standefer, Duvall, WA (US); Christopher Mullins, Redmond, WA (US)

(73) Assignee: Microsoft Technology Licensing, LLC, Redmond, WA (US)

(21) Appl. No.: 15/462,385

(22) Filed: Mar. 17, 2017

(51) Int. Cl. G06F 17/30

(52) U.S. Cl. CPC G06F 17/30292; G06F 17/30958

(57) ABSTRACT

Examples of the present disclosure describe systems and methods relating to rule hierarchies for graphs or isolated collections. In an example, information in an isolated collection may relate to one of multiple levels in a hierarchy. As such, mapping rules may adapt level-specific information such that it is understandable or useable by other levels within the hierarchy. In some examples, mapping rules may be hierarchical, such that a mapping rule of one layer may be used to adapt a mapping rule from another layer. In other examples, mapping rules may be reused by other levels of the hierarchy when it is determined that they may be relevant or useful to apply to other level-specific information. Adaptation of information using mapping rules may enable information that was previously inaccessible to be accessed by a more general audience, thereby mitigating potential data silos and further enriching the available information.

### BACKGROUND

Information may be stored in an isolated collection or other storage system by multiple levels within an organization or other hierarchy. Level-specific information may be stored in the isolated collection, such that other levels of the hierarchy may be unfamiliar with characteristics of such information. As a result, data silos and other inefficiencies may exist within the isolated collection, thereby reducing the accessibility and usability of information within the storage system.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods relating to rule hierarchies for a graph or isolated collection. In an example, information in an isolated collection may relate to one or more levels within an organization, a tenant of a computing system, or other hierarchy. Given the level-specific nature of the information, information in the isolated collection may become siloed, making it difficult for other users or clients of the isolated collection to access or search for such information. As such, mapping rules may be used within the isolated collection in order to adapt level-specific information to be understandable or useable by other levels of the hierarchy. This may enable information that was previously inaccessible without level-specific knowledge to be accessed by a more general audience, thereby mitigating potential data silos and further enriching the information available within the isolated collection.

In some examples, mapping rules and/or mapping rulesets may be hierarchical, such that a mapping rule of one layer may be used to adapt a mapping rule from another layer. A mapping ruleset may be manually associated with information in an isolated collection, or may be automatically applied based on a determination that the mapping rule may be related to the information. In other examples, mapping rules may be made available within the isolated collection, such that levels of the hierarchy for which a mapping rule was not originally created to apply may evaluate the mapping rule and determine whether the mapping rule describes a relevant or useful relationship that may not have previously existed in level-specific information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for generating, applying, and/or managing a rule hierarchy.

FIG. 2 illustrates an overview of an example system for managing isolated collections of resource identifiers and corresponding relationships.

FIG. 3A illustrates an overview of an example isolated collection.

FIGS. 3B-3E illustrate an example query model that may be used to traverse an isolated collection.

FIGS. 4A-4C illustrate overviews of an example isolated collection.

FIG. 5 illustrates an overview of an example rule hierarchy.

FIG. 6 illustrates an overview of an example method for generating a mapping rule in a rule hierarchy.

FIG. 7 illustrates an overview of an example method for processing an isolated collection using a rule hierarchy.

FIG. 8 is a block diagram illustrating example physical components of a computing device with which aspects of the disclosure may be practiced.

FIGS. 9A and 9B are simplified block diagrams of a mobile computing device with which aspects of the present disclosure may be practiced.

FIG. 10 is a simplified block diagram of a distributed computing system in which aspects of the present disclosure may be practiced.

FIG. 11 illustrates a tablet computing device for executing one or more aspects of the present disclosure.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Information from a variety of sources within an organization may be stored using a graph or an isolated collection. Each source may be a level within the hierarchy of the organization, such that at least some of the levels or sources may be related to each other within the hierarchy. The information may have specific characteristics associated with it due to the level to which it relates. In an example, the information may have specific naming or organizational conventions, may relate to a specific domain of information, may be private or access-restricted, or may use specific terminology, among other level-specific characteristics. While such level-specific characteristics may not present a problem when the information is accessed in a context having knowledge of the level-specific characteristics (e.g., by a user or client within the level), it may become difficult to access or share information across or between levels without having a familiarity of such intricacies associated with any given level, much less multiple levels of the hierarchy. As such, information within the isolated collection may become siloed or may be difficult to access for other users or clients of the isolated collection without such level-specific knowledge.

The present disclosure provides systems and methods relating to rule hierarchies for graphs or isolated collections. In an example, information may relate to one or more levels within a hierarchy, including, but not limited to, a team or group within an organization, a group of users relating to one or more tenants of a computing system, or a department in an enterprise system. Information from multiple levels of the hierarchy may be stored in the same isolated collection, using multiple isolated collections, or a combination thereof. The information may comprise or relate to data that is level-specific (e.g., it may relate to a context of the level, it may provide detail that is relevant within the level, or it may be private to the level, among other level-specific characteristics). In an example, one or more rules relating to the information may be level-specific, such as an inference rule used to infer a resource type, a relationship, or make other inferences relating to the information in the isolated collection, as will be discussed in greater detail below. However, given the level-specific nature of the information, information in the isolated collection may become siloed such that it may be difficult for other users of the isolated collection to access or search for the information (e.g., because level-specific terms are used to identify the information, because the structure of the information is different than would be used at other levels of the hierarchy, etc.). As such, mapping rules may be used within the hierarchy in order to adapt a level-specific rule or descriptor to one that is understandable or useable by other levels of the hierarchy. This may enable information that was previously inaccessible without specific knowledge of a given level to be accessed by a more general audience, thereby mitigating potential data silos and further enriching the overall information that is available within the isolated collection.

In some examples, a graph or isolated collection may be comprised of resources and relationships. A resource may be a document, information relating to a document (e.g., a revision, a comment or annotation, metadata, properties, etc.), a message, a conversation, a presence update or indication, a calendar event, a user resource comprising information relating to a user (e.g., a username, a user identity, an email address, a phone number, etc.), among others. A document may contain any kind of information, including, but not limited to, text data, image or video data, audio data, drawings, simulations, 3D models, cryptographic keys, shared secrets, calculations, algorithms, recipes, formulas, or any combination thereof. In some examples, a resource may be identified by a resource identifier, which may be a durable Uniform Resource Identifier (URI) pointing to the particular resource. The resource identifier may also be a uniform resource locator (URL), uniform resource name (URN), or other suitable identifier or pointers pointing to the resource itself. In one example, the resource may be stored within an isolated collection. In another example, the resource may be stored in a data collection, while an associated resource identifier may be stored in an isolated collection. For example, the resource may reside on a remote server, and the resource identifier may be used to retrieve the resource (e.g., the resource may be stored on a remote web server, where the resource identifier comprises a URL). Identifying the location of a resource may include parsing the resource identifier using, for example, regular expressions, providing one or more portions of the resource identifier to a search utility, executing the resource identifier, etc. Relationships within the isolated collection may identify a correlation between two or more resources in the isolated collection. In some examples, an isolated collection may be a plurality of universal data nodes (UDNs), a document graph, or other collection of resources and relationships.

The resources, or resource identifiers, and/or relationships may be provided by a developer or other external source. Such resources, resources identifiers, and relationships are referred to herein as asserted resources, asserted resource identifiers, and asserted relationships. Each isolated collection may also be enriched to create additional relationships and in some examples additional resource identifiers, by executing a ruleset against the data already in the isolated collection. The additional data generated through execution of such a ruleset is referred to herein as inferred data, such as inferred relationships, inferred resources, and inferred resource identifiers. Queries may then be executed against the isolated collection that includes both the asserted data and inferred data to provide richer results than would otherwise be available solely from the asserted data alone. The isolated collection may also be stored as graph database, and results to queries of the isolated collection may be displayed in a graphical format wherein resources are displayed as nodes and the relationships are displayed as edges, among other display formats (e.g., as a tree, a directed graph, a matrix, a table, etc.). As used herein, an isolated collection of resource identifiers and the relationships between those resources or resource identifiers may be referred as a “Set.” Further, access to the isolated collection may be controlled through various techniques to provide additional security measures for the content in each isolated collection, and each isolated collection may have different rule sets to generate unique and different inferred data to meet the particular needs of each application.

In an example, one or more of the rules in a ruleset may be used to infer relationships, resources, and/or resource identifiers that are level-specific. Such rules may be deemed herein to comprise a level-specific ruleset. A mapping rule may be used to adapt a rule from a level-specific ruleset to match another rule of the isolated collection (e.g., a rule in another level-specific ruleset, a rule associated with the isolated collection as a whole, etc.). In another example, a mapping rule may be used to adapt other level-specific information (e.g., information associated with an asserted resource, an asserted relationship, etc.) to match other information of the isolated collection. As such, a mapping ruleset comprising one or more mapping rules may be used to adapt information that is specific to a level within a hierarchy such that it conforms to resource types, relationships, or other attributes of the isolated collection.

In some examples, mapping rulesets may be hierarchical, such that a mapping rule of one layer may be used to adapt a mapping rule from another layer. As a result, multiple levels of a hierarchy may be adapted to conform to the attributes of another level. For example, a mapping ruleset may be associated with a base level. The mapping ruleset may define one or more mapping rules used to adapt information from the base level to an intermediate level, thereby making information of the base level accessible to those having an understanding of the information in the intermediate level. Similarly, a mapping ruleset may be associated with the intermediate level, such that the mapping ruleset may define one or more mapping rules used to adapt information from the intermediate level to a higher level. In an example, given that information of the base level was adapted to the intermediate level, information of the base level may be further adapted using the mapping ruleset of the intermediate level such that the information from the base level is adapted to the higher level (e.g., by applying a mapping ruleset for the base level in conjunction with a mapping ruleset for the intermediate level). While the instant example relates to adapting information between three levels of a hierarchy, it will be appreciated that information may be adapted between any number of hierarchical levels or in any direction. In some examples, a mapping rule may adapt information from a first level to a second level, wherein the second level is not directly associated with the first level (e.g., directly from the base level to the higher level, from the higher level to the base level, from one division of an organization to another indirectly-related division, or between two different groups of users of an enterprise system, among other mapping rules).

Information generated by a mapping rule (e.g., inferred relationships, inferred resources, etc.) may be stored in or associated with the isolated collection, may be generated dynamically (e.g., when the data is accessed, queried, etc.), or stored separate from the isolated collection, among other techniques. In some examples, a set of one or more mapping rules may be applied to information in an isolated collection in order to determine how the mapping rules may affect at least a subpart of the isolated collection. As a result, a plurality of mapping rules may be used in conjunction with one another in order to evaluate the resulting structure and/or content of the isolated collection. In other examples, the set of mapping rules may be revised (e.g., by adding or removing mapping rules, by modifying a mapping rule, etc.) in order to refine or iterate on the mapping ruleset applied to the isolated collection.

In another example, one or more mapping rules and/or mapping rulesets may be automatically applied to information within an isolated collection based on a determination that a mapping rule relates to a similar type of information (e.g., having similar properties, attributes, relationships, resource types, metadata, or based on other similarities), a similar level of a hierarchy (e.g., in relation to one or more other levels, based on the type of information with which the level is associated, etc.), among other determinations. In some examples, the mapping rule may be automatically applied in response to a query or access request for information in the isolated collection. In an example, the automatic application of one or more mapping rules may be the result of a previous preference indication that relevant mapping rules should be identified and/or used when interacting with information stored in an isolated collection. In another example, similar mapping rules may be identified and used to provide an indication that there may be one or more mapping rules that may be used to augment or improve the accessibility of information associated with a level of the isolated collection. The indication may then be used to select and/or apply one or more of the mapping rules.

At least a subpart of a mapping ruleset may be made available within a hierarchy (e.g., to other users of the isolated collection, or other services or applications, etc.), such that it may be determined whether a mapping rule may be used to evaluate information other than the information for which the mapping rule was intended. For example, a mapping rule may be created to map information from a first level of a hierarchy to a second level of the hierarchy, wherein the first level is directly below the second level. The mapping rule may be reused to map information from a third level of a hierarchy, wherein the third level is below the second level (e.g., either below the second level, separated from the second level by one or more levels, etc.). In another example, the third level of the hierarchy may be above the second level, or may be at a different branch of the hierarchy (e.g., where the second and third levels share a common parent). Thus, a mapping rule or a mapping ruleset may be reusable within the hierarchy, such that the mapping rule may be used to adapt information other than the information for which it was originally created. As will be appreciated, while a specific hierarchical structure is given as an example, a mapping rule and/or mapping ruleset may be made available and used to adapt information associated with any level in a hierarchy.

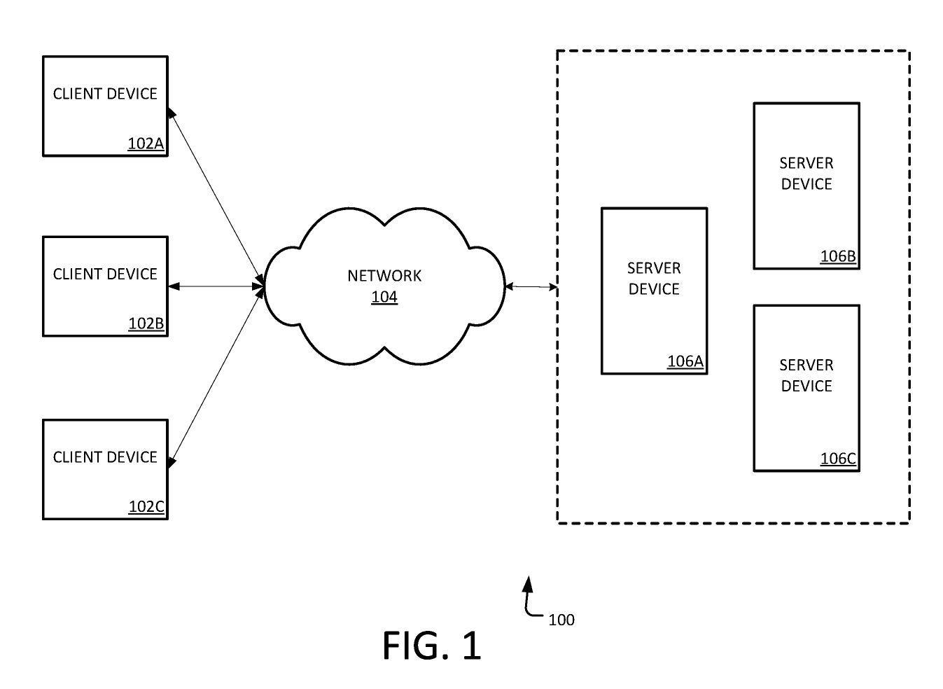

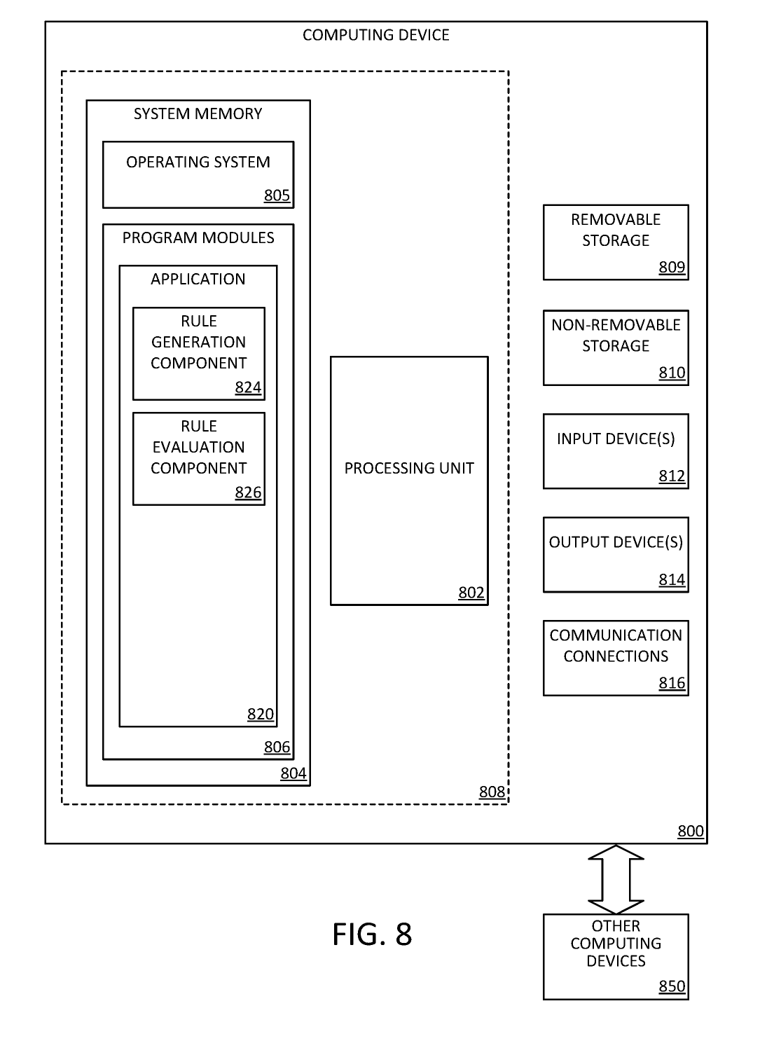

FIG. 1 illustrates an overview of an example system for generating, applying, and/or managing a rule hierarchy. Example system 100 may be a combination of interdependent components that interact to form an integrated whole for performing aspects disclosed herein. In aspects, system 100 may include hardware components (e.g., used to execute/run operating system (OS)), and/or software components (e.g., applications, application programming interfaces (APIs), modules, virtual machines, runtime libraries, etc.) running on hardware. In particular aspects, system 100 may provide an environment for software components to execute, evaluate operational constraint sets, and utilize resources or facilities of the system 100. In such aspects, the environment may include, or be installed on, one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic device. As an example of a processing device operating environment, refer to the exemplary operating environments depicted in FIGS. 8-11. In other instances, the components of systems disclosed herein may be distributed across and executable by multiple devices. For example, input may be entered on a client device and information may be processed or accessed from other devices in a network (e.g. server devices, network appliances, other client devices, etc.).

As presented, system 100 comprises client devices 102A-C, distributed network 104, and a distributed server environment comprising one or more servers, such as server devices 106A-C. One of skill in the art will appreciate that the scale of systems such as system 100 may vary and may include additional or fewer components than those described in FIG. 1. In some aspects, interfacing between components of the system 100 may occur remotely, for example, where components of system 100 may be distributed across one or more devices of a distributed network.

In aspects, client devices 102A-C may be configured to receive input via a user interface component or other input means. Examples of input may include voice, visual, touch and text input. The interface component may enable the creation, modification and navigation of various data sets and graphical representations. In examples, the various datasets may comprise (or be otherwise associated with), for example, resource identifiers, resource metadata, relationship information, asserted relationships, graphical mapping information, query data, rule sets, such as, for example, inference rules, authorization information, authentication information, etc., as discussed in further detail below. Generally, the datasets are stored on one or more server devices 106A-C and are accessible by the client devices 102A-C. In some examples, however, the datasets may be at least partially stored on one or more of the client devices 102A-C. The underlying resources represented in the various datasets may be stored locally or in a data store, such as a cloud storage application, accessible to client devices 102A-C. In at least one example, the underlying resources represented in the various datasets (or portions thereof) may be distributed across client devices 102A-C. For instance, client device 102A (e.g., a mobile phone) may locally store a first portion of the resources represented in the dataset, client device 102B (e.g., a tablet) may locally store a second portion of the resources, and client device 102C (e.g., a laptop) may locally store the remaining portion of the resources represented in the dataset. In examples, the client devices 102A-C may have access to all of the resources included in the data set, may have access to a subset of the resources included in the dataset, or, alternatively, may not have access to any of the resources included in the dataset.

Client devices 102A-C may be further configured to interrogate data stores comprising the resources corresponding to the resource identifiers in the various data sets. In examples, client devices 102A-C may interrogate content providers, such as server device 102A-C, via distributed network 104. The interrogation may include identifying the remote device on which a resource is located, and/or determining whether the remote device (or a service/separate remote device) has authenticated access to the resource. If access to the resource has been authenticated, client devices 102A-C may retrieve an authentication indication from the remote device. Client devices 102A-C may use the authentication indication to provide access to one or more of the various datasets comprising the corresponding resource identifier.

Server devices 106A-C may be configured to store and/or provide access to one or more resources. For example, server device 102A may be a web server, server device 102B may be a device comprising a collaborative messaging tool and a calendaring application, and server device 102C may be electronic mail server. Each of these devices may comprise a repository of resources that is accessible via one or more authentication mechanisms. In examples, server devices 106A-C may perform or monitor the authentication process when a request for a resource is received. If the authentication is successful, the authenticating device may store or maintain an authentication indication for a specified period of time. When the period of time expires, server devices 106A-C may remove or attempt to renew the authentication indication. In examples, server devices 106A-C may provide the authentication indication to an interrogating client device. In some aspects, server devices 106A-C may further be configured to store at least a portion of the various data sets and graphical representations, as discussed above.

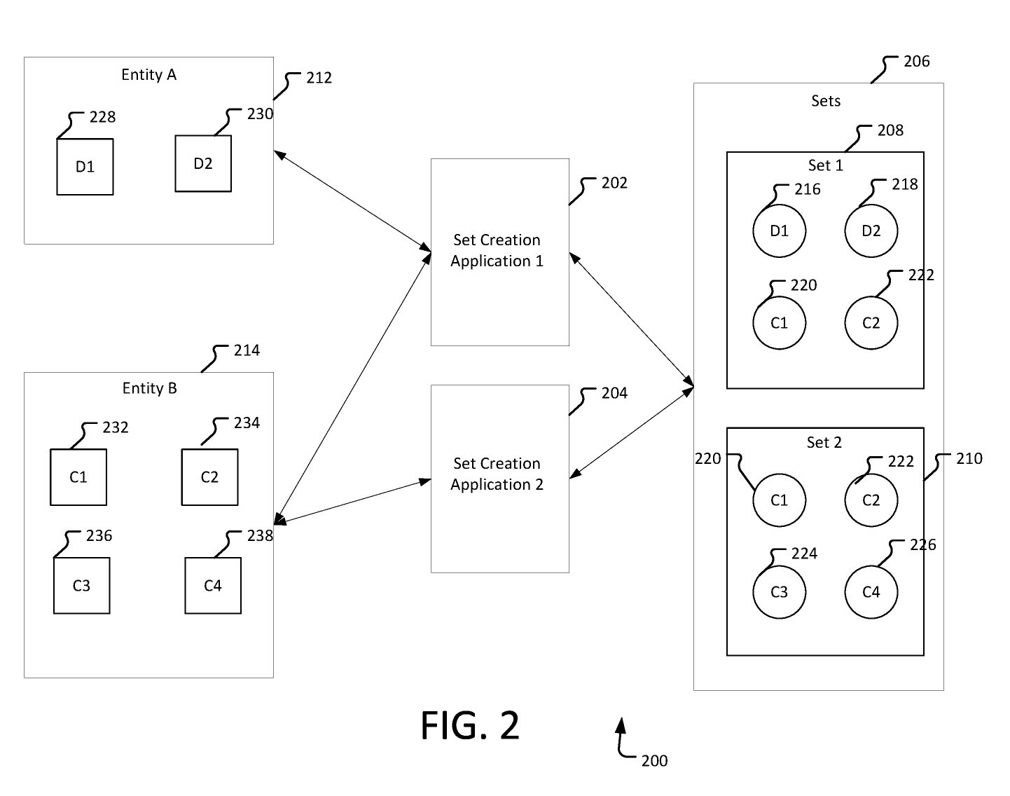

FIG. 2 illustrates an overview of an example system 200 for managing isolated collections of resource identifiers and corresponding relationships. The isolated collection techniques implemented in system 200 may comprise or be associated with one or more of the techniques described in FIG. 1. In alternative examples, a single device (comprising one or more components such as processor and/or memory) may perform the processing described in systems 100 and 200, respectively.

With respect to FIG. 2, system 200 may comprise Set creation applications 202 and 204, Set environment 206, Sets 208 and 210, entities 212 and 214, resources identifiers 216, 218, 220, 222, 224 and 226, and resources 228, 230, 232, 234, 236 and 238. In aspects, Set creation applications 202 and 204 may be an application or service configured to create, infer, manipulate, navigate and visualize various resources, relationships and graphical representations. Set creation applications 202 and 204 may define collections of relationships between resources (e.g., people, files, tasks, mail, documents, calendar events, etc.) and executing queries on those collections. Set creation applications 202 and 204 may further provide for defining and storing rulesets used to infer one or more relationships in the collections, and displaying graphical representations of the collection data. The defined rulesets may be stored in the Set itself, and in some examples is stored as metadata within the Set. In examples, Set creation applications 202 and 204 may be installed and executed on a client device or on one or more devices in a distributed environment. For instance, Set creation application 202 may be installed on client device 102A, Set creation application 204 may be installed on client device 102B, and a Set creation service associated with server device 106A may be accessible to client device 102C.

In aspects, Set creation applications 202 and 204 may have access to a file directory or an execution environment, such as environment 206. Environment 206 may be collocated with a Set creation application, or environment 206 may be located remotely from the Set creation application. Environment 206 may provide access to one or more data collections, such as Sets 208 and 210. In examples, access to the data collections may be determined using one or more sets of permissions generated and/or maintained by Set creation applications 202 and 204. The sets of permissions may be different across one or more of the data collections. As a result, one or more of the data collections (or functionality associated therewith) may not be accessible from one or more of Set creation applications 202 and 204.

Sets 208 and 210 may respectively comprise isolated collections of asserted resource identifiers and corresponding relationships. The relationships in the isolated collections may be defined manually or may be automatically derived using one or more rulesets. The isolated collections may be represented using graphical structures that directly relate resources in the data collection and provide for retrieving relationship data with a single operation. Each isolated collection may comprise resource identifiers that are unique to that isolated collection. Alternately, the isolated collections may comprise resource identifiers included in one or more alternate isolated collections. For example, as depicted in FIG. 2, Set 208 may comprise resource identifiers 216, 218, 220 and 222, and Set 210 may comprise resource identifiers 220, 222, 224 and 226. Resource identifiers 216, 218, 220, 222, 224 and 226 may correspond to, and/or identify the location of, one or more resources. As used herein, a resource identifier references an existing resource, but is not itself a resource. Exemplary types of resource identifiers include, but are not limited to, a Uniform Resource Identifier (e.g., a Uniform Resource Locator (URL), a Uniform Resource Name (URN) etc.), an IP address, a memory or storage address, and the like. One of skill in the art will appreciate that any type of identifier may be employed by the various aspects disclosed herein without departing from the scope of this disclosure. Identifying the location of a resource may include parsing the resource identifier using, for example, regular expressions, providing one or more portions of the resource identifier to a search utility, executing the resource identifier, etc. In aspects, having access to the data collections does not guarantee access to the resources identified by the resource identifiers included in each data collection. For example, although a user may be able to access and manipulate Set 208, the user may not be authorized to access one or more of the underlying resources corresponding to the resource identifier in Set 208.

Resource providers 212 and 214 may be configured to store and/or provide access to one or more resources. As such, a resource provider as used herein may be a data store, a cloud service provider, a client computing device, a server computing device, a distributed system of devices, such as, for example, an enterprise network, an application, a software platform (e.g., an operating system, a database, etc.), and the like. In aspects, resource providers 212 and 214 may be (or have access to) various different data sources, such as content providers, data stores, various sets of application data, and the like. The data stores may comprise one or more resources corresponding to one or more resource identifiers. For example, as depicted in FIG. 2, resource provider 212 may be a data store comprising various different types of resources such as resource 228 (e.g., document 1 (D1)) and resource 230 (e.g., presentation 2 (P1)) and resource provider 214 may be a contact management application comprising contact resources 232 (e.g., contact 1 (C1)), 234 (e.g., contact 2 (C2)), 236 (e.g., contact 3 (C3)) and 238 (e.g., contact 4 (C4)). In this example, resource identifier 216 may correspond to resource 228; resource identifier 218 may correspond to resource 230; resource identifier 220 may correspond to resource 232; resource identifier 222 may correspond to resource 234; resource identifier 224 may correspond to resource 236; and resource identifier 226 may correspond to resource 238. In some aspects, resource providers 212 and 214 may be accessible by Set creation applications 202 and 204. Set creation applications 202 and 204 may access resource providers 212 and 214 to determine the existence of resources and/or retrieve information associated with the resources (e.g., resource metadata, resource location, resource identifiers, permission sets, authentication data, etc.). The information retrieved from resource providers 212 and 214 may be used to determine a set of resource identifiers corresponding to one or more of the available resources. The set of resource identifiers may be used to create one or more isolated collections of asserted resource identifiers and corresponding relationships. As noted above, the resource identifiers may be, or include, a durable URI for its corresponding resource. For instance, the resource identifier 216 may include the URI for the actual document (D1) 228. Accordingly, in such an example, a user is able to determine the location of the document (D1) 228 from the Set, and, depending on authentication and access restrictions, retrieve the document (D1) 228. As another example, as depicted in FIG. 2, resource provider 212 may be accessed by Set creation application 202. Set creation application 202 may determine that resource provider 212 comprises at least resources 228 and 230, and may determine resource identification information for each of the resources. Based on the determined resource identification information, resource identifiers 216 and 218 may be respectively applied/correlated to resources 228 and 230, and provided to environment 206. Environment 206 may then make resource identifiers 216 and 218 eligible for an inclusion analysis into one or more isolated collections.

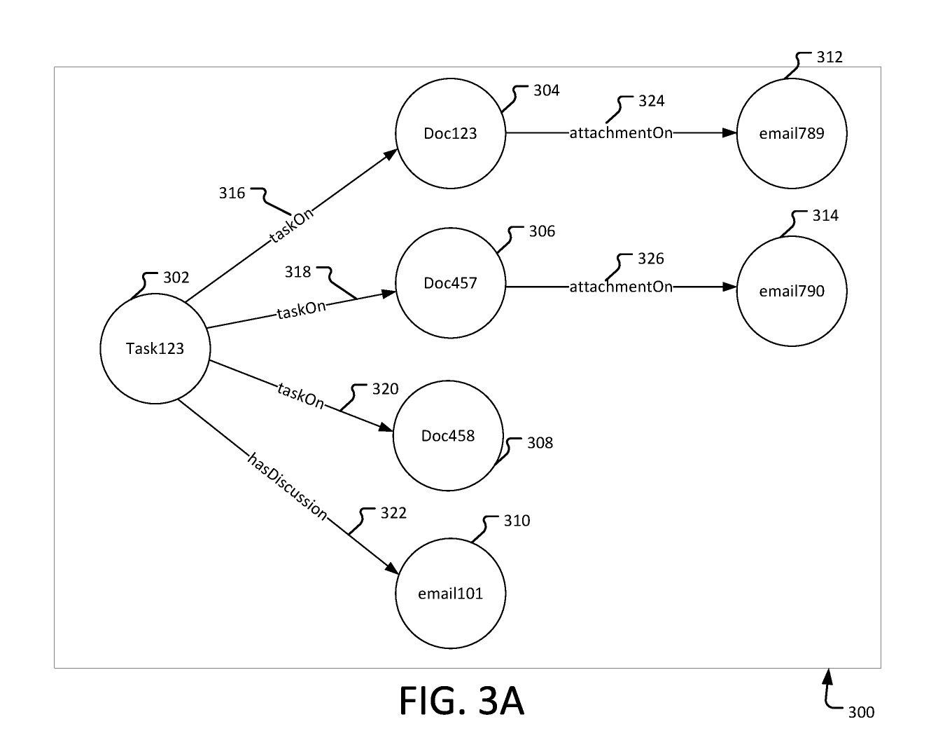

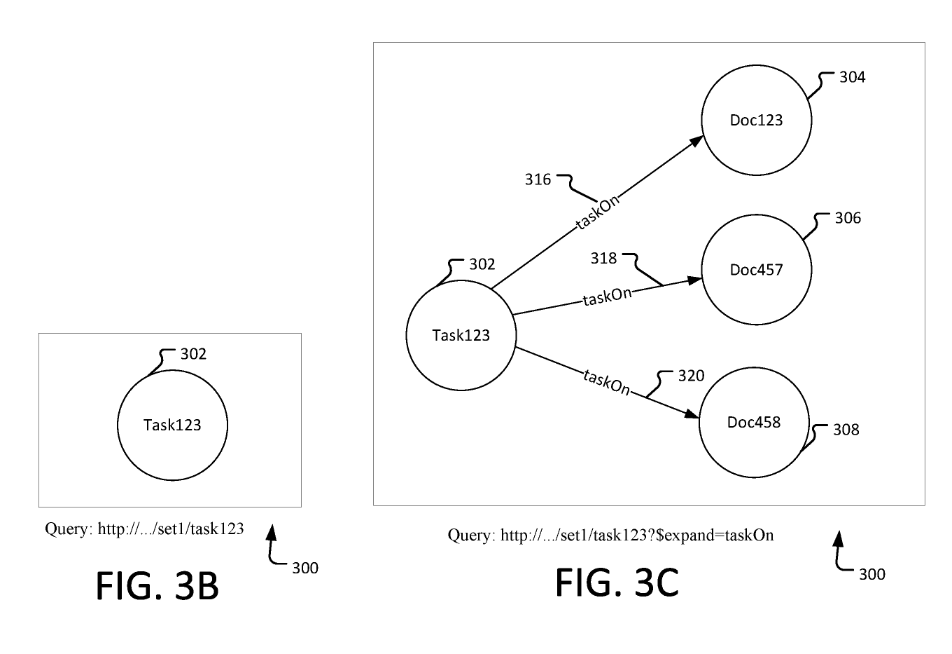

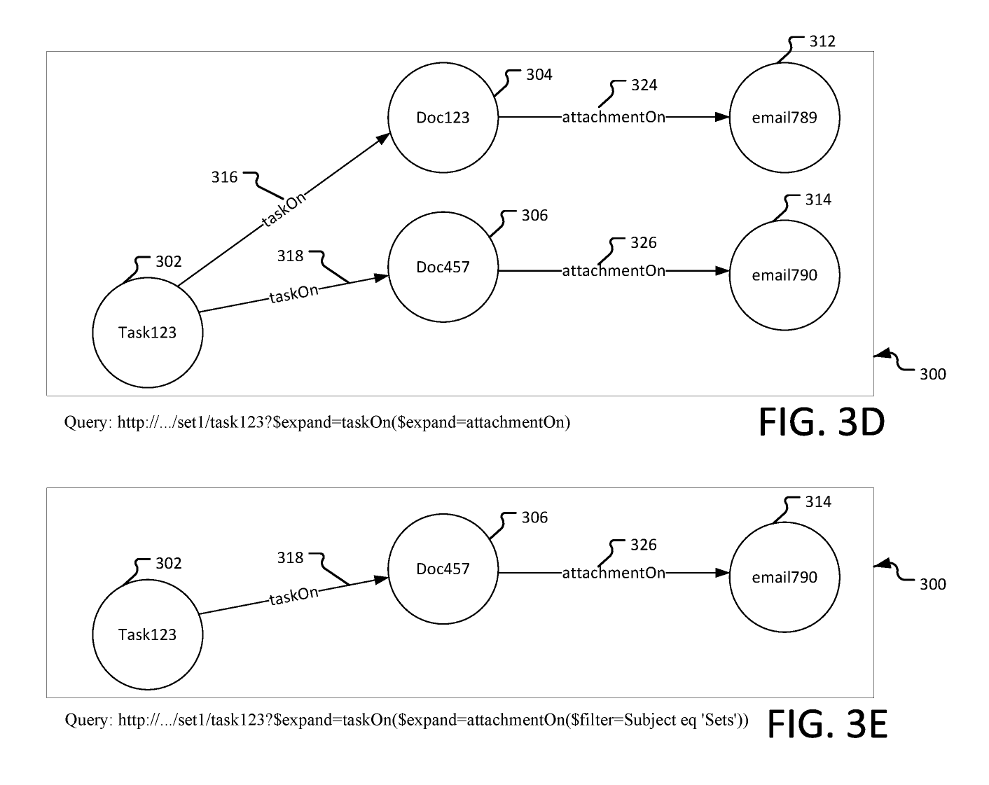

FIG. 3A illustrates an example isolated collection 300 of asserted resource identifiers and corresponding relationships. Example isolated collection 300 comprises resource identifiers 302, 304, 306, 308, 310, 312 and 314, and relationships 316, 318, 320, 322, 324 and 326. In aspects, isolated collection 300 may be generated and/or manipulated using a collection creation utility that may be included as part of a Set creation application as discussed above. When presented in graph form as depicted in the FIG. 3A, each resource identifier may be referred to as a “node” and each relationship may be referred to as an “edge.” The collection creation utility may also identify resources and/or determine resource types for collections using one or more rulesets that may include rules defined in accordance with semantic web technologies, such as resource description framework (RDF), RDF schema (RDFS), SPARQL Protocol and RDF Query Language (SPARQL), Web Ontology Language (OWL), etc. For example, collection 300 includes a resource identifier 312 that represents an underlying resource, “email789” in the depicted example. Similarly, resource identifier 304 represents a resource document, “Doc123,” and resource identifier 302 represents a resource task, “Task123.” Each of the resources and relationships included in the isolated collection 300 may have been asserted by a developer through a Sets creation application. For instance, a developer may manually add each of the resource identifiers and the relationships between the resource identifiers. As an example, the developer may manually indicate that the “task123” is a task on “Doc123,” as represented in the collection 300 by the “taskOn” relationship 316. The resource identifiers and relationships may also be asserted by an external bot or application created by a developer. For instance, an add-in may be programmed to monitor activity in a browser or other application to track usage of the application. Based on the usage of the application, the add-in sends additional resources and relationships to be included in the collection 300.

In contrast to the asserted resource identifiers and relationships, a collection creation utility may execute a ruleset to determine additional relationships and resource types, referred to herein as “inferred relationships” and “inferred resource identifiers” or “inferred resource types.” For example, upon execution of a ruleset, the collection creation utility may determine that resource identifier 312 represents an email message, and resource identifier 304 represents a document. Generation of inferred relationships and resources is discussed in further detail below.

Isolated collection 300 further depicts that resource identifier 302 is associated with resource identifiers 304, 306 and 308 and resource identifier 310. The collection creation utility may determine that the resource identifier 302 represents a task to be performed on identifiers 304, 306, and 308. Based on this determination, the collection creation utility may assign relationships 316, 318 and 320 (e.g., “taskOn”) to define the association between resource identifier 302 and resource identifier 304, 306 and 308. In other examples, the relationships 316, 318, and 320 may be asserted, as discussed above. Additional relationships, such as the “hasDiscussion” relationship 322 may have been asserted manually by a developer or asserted from an add-in of an e-mail application that analyzed the content of e-mail 101. While specific types of resources and relationships are described in FIG. 3A, one of skill in the art will appreciate that other types of resources and/or relationships may be included in an isolated collection without departing from the spirit of this disclosure.

FIGS. 3B-3E illustrate an example query model that may be used to traverse collection 300. In aspects, queries may be executed via an interface provided by the collection creation utility. A query may be executed against one or more files and/or directories comprising information, such as resource identifiers, resource type, resource metadata, permission data, etc. The query results may be visualized in a graph form as one or more collections, such as collection 300. For example, the entire collection 300 dataset may comprise only those elements illustrated in collection 300 (e.g., resource identifiers 302, 304, 306, 308, 310, 312 and 314 and relationships 316, 318, 320, 322, 324 and 326). In this particular example, resource identifier 312 may represent an email comprising the subject “API Design” and resource identifier 314 may represent an email comprising the subject “Sets.” The query ‘http:// . . . /collection300/task123’ may be executed against collection 300. The query results may comprise resource identifier 302 and be visualized as illustrated in FIG. 3B. In FIG. 3C, the query has been amended to ‘http:// . . . /collection300/task123?$expand=taskOn’ and executed against collection 300. The query results may comprise resource identifiers 302, 304, 306 and 308 and relationships 316, 318 and 320, and be visualized as illustrated in FIG. 3C. In FIG. 3D, the query has been amended to ‘http:// . . . /collection300/task123?$expand=taskOn($expand=attachmentOn)’ and executed against collection 300. The query results may comprise resource identifiers 302, 304, 306, 308, 312 and 314 and relationships 316, 318, 320, 324 and 326, and be visualized as illustrated in FIG. 3D. In FIG. 3E, the query has been amended to http:// . . . /collection300/task123?($expand=taskOn($expand=attachmentOn)($filter=Subject eq ‘Sets’))′ and executed against collection 300. As only resource identifier comprises 314 the subject “Sets”, the query results may comprise resource identifiers 302, 306 and 314 and relationships 318 and 326, and be visualized as illustrated in FIG. 3E.

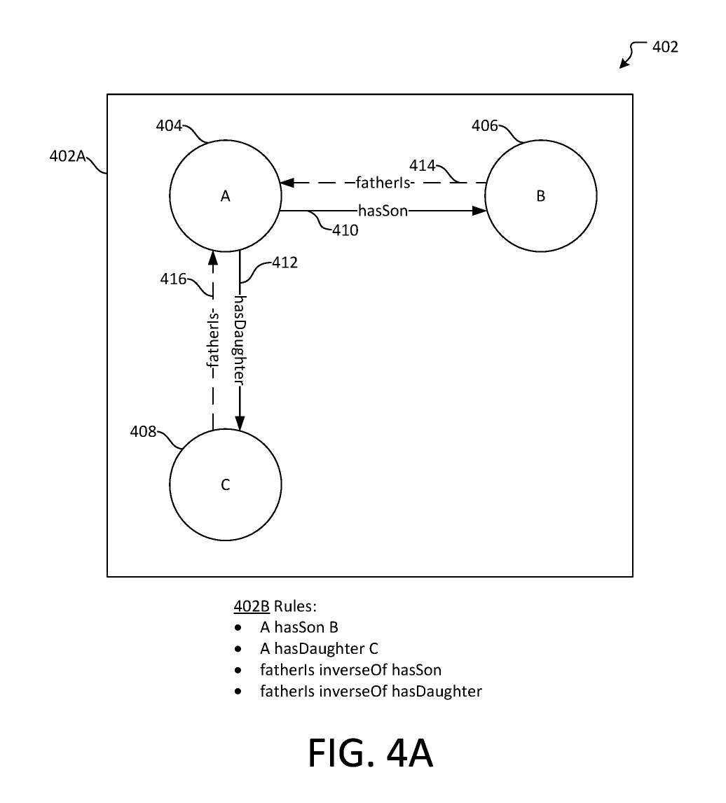

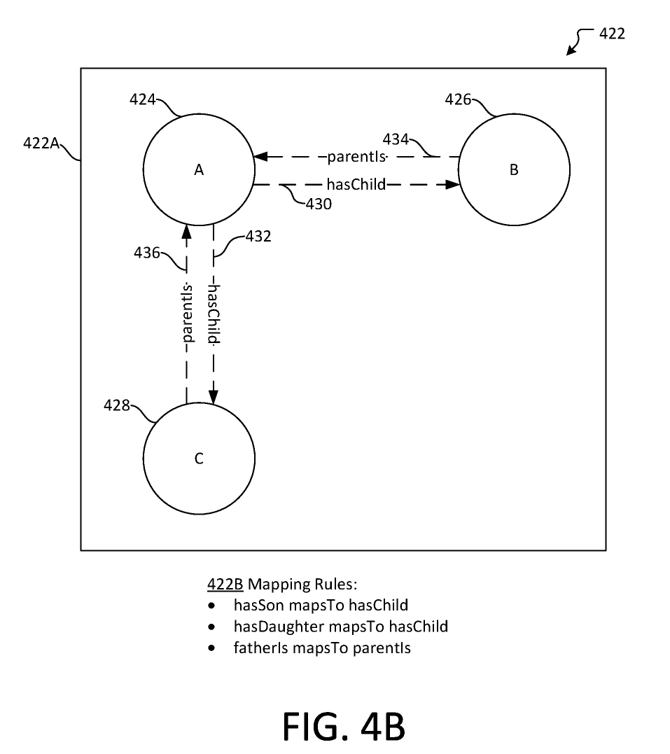

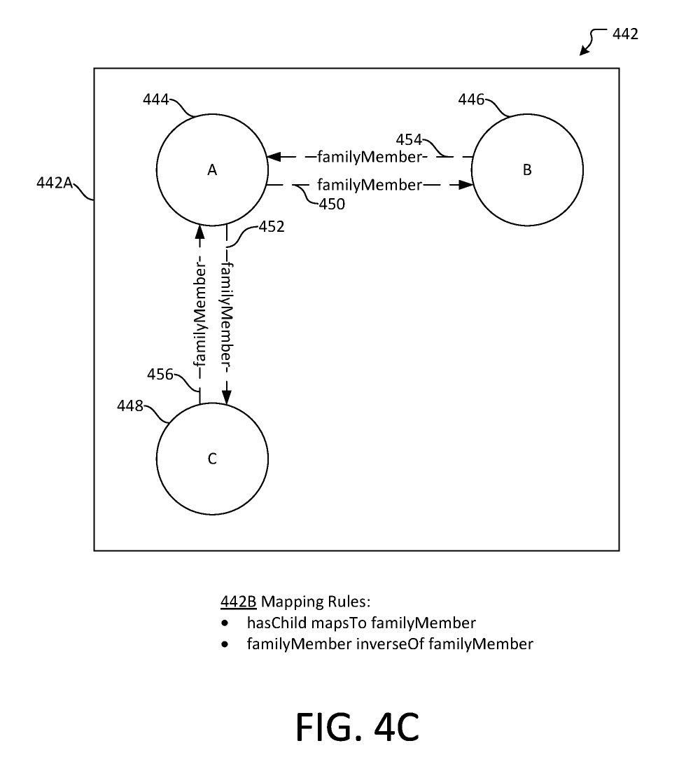

FIGS. 4A-4C illustrate overviews of an example isolated collection according to aspects disclosed herein. As will be discussed in greater detail below, FIG. 4A illustrates information in an isolated collection that is associated with a level of a hierarchy. FIG. 4B illustrates the isolated collection of FIG. 4A, but as adapted using a mapping ruleset. Similarly, FIG. 4C illustrates the isolated collection as in FIGS. 4A and 4B, but again adapted using a mapping ruleset.

FIG. 4A illustrates an example isolated collection 402 having a plurality of resource identifiers and relationships. As depicted in visual representation 402A, isolated collection 402 includes resource A 404, resource B 406, and resource C 408. In an example, resources 404-408 may be associated with a level of a hierarchy, wherein the resource types, relationships, or other attributes may be layer-specific (e.g., related to a context of the layer, relevant to the layer, private to the layer, etc.). Resources 404-408 may be associated with people, and relationships 410-416 may indicate relationships among the people to which they relate.

As illustrated, relationship 410 uses a solid arrow to indicate that an asserted relationship of “hasSon” exists between resource A 404 and resource B 406. Relationship 410 is directional in that it indicates that resource A 404 has a son of resource B 406, rather than the other way around. Similarly, relationship 414 uses a dashed arrow to indicate that an inferred relationship of “fatherIs” exists between resource B 406 and resource A 404. Relationship 414 is directional in that it indicates that the father of resource B 406 is resource A 404, rather than the other way around. Further, relationship 412 uses a solid arrow to indicate that an asserted relationship of “hasDaughter” exists between resource A 404 and resource C 408. Relationship 412 is directional in that it indicates that resource A has a daughter of resource B 408, rather than the other way around. Similarly, relationship 416 uses a dashed arrow to indicate that an inferred relationship of “fatherIs” exists between resource C 408 and resource A 404. Relationship 416 is directional in that it indicates that the father of resource C 408 is resource A 404, rather than the other way around.

Rules 402B may be used to describe isolated collection 402 and to generate visual representation 402A. The first rule, “A hasSon B,” is an asserted relationship, which is visualized by relationship 410 between resource A 404 and resource B 406. Similarly, the second rule, “A hasDaughter C,” is an asserted relationship visualized by relationship 412 between resource A 404 and resource C 408. The two remaining rules, “fatherIs inverseOf hasSon” and “fatherIs inverseOf hasDaughter,” may be inferred rules that may reside in an inference ruleset and are visualized as relationships 414 and 416, respectively.

As discussed above, isolated collection 402 (e.g., visual representation 402A and rules 402B) may be associated with information that is level-specific within a hierarchy (e.g., an organization, a social circle comprising users of a social network, etc.). As such, one or more mapping rules may be generated in order to adapt information (e.g., resources, relationships, properties, etc.) of isolated collection 402 to other levels of a hierarchy. With reference to FIG. 4B, isolated collection 422 may be an adaptation of isolated collection 402 based on mapping rules 422B.

As illustrated, mapping rules 422B comprises three rules. The first rule, “hasSon mapsTo hasChild,” may indicate that a “hasSon” relationship (e.g., relationship 410 in FIG. 4A) may be mapped to a “hasChild” relationship in isolated collection 422. This may be represented by hasChild relationship 430 between resource A 424 and resource B 426. Similarly, the second rule, “hasDaughter mapsTo hasChild,” may indicate that a “hasDaughter” relationship (e.g., relationship 412 in FIG. 4A) may be mapped to a “hasChild” relationship in isolated collection 422. This may be represented by hasChild relationship 432 between resource A 424 and resource C 428. The final rule, “fatherIs mapsTo parentIs,” may indicate that a “fatherIs” relationship (e.g., relationships 414 and 416 in FIG. 4A) may be mapped to a “parentIs” relationship in isolated collection 422. This may be represented by parentIs relationships 434 and 436 between resource B 426 and resource A 424, and resource C 428 and resource A 424, respectively. Relationships 430-436 are illustrated using dashed arrows, which may indicate that the relationships were inferred as a result of applying mapping rules. Further, relationships 430-436 are directional, indicating directional relationships among resources 424-428 (e.g., that resource A 424 has children resource B 426 and resource C 428, rather than the other way around).

Mapping rules 422B may be used to adapt information in isolated collection 402 for a variety of reasons, such as making the information more accessible or more organized with respect to other information in the isolated collection, providing or enforcing security requirements (e.g., limiting access to personal or confidential information, generating a mandatory relationship between two resources, etc.), among other reasons. With reference to FIG. 4C, the information in isolated collection 402 and/or isolated collection 422 may be further adapted using mapping rules 442B. As illustrated, isolated collection 442 may comprise similar relationships 450-456 between resources 444-448, but the specificity or type of information indicated by relationships 450-456 may be further altered or adapted by way of mapping rules 442B.

The first mapping rule, “hasChild mapsTo familyMember,” and related relationships 450 and 452 may filter personal information, thereby adapting specific familial relationships to a more general form. Rather than adapting information from isolated collection 422 (e.g., “parentIs mapsTo familyMember”), the second rule may instead provide an inference based on information generated from another mapping rule: “familyMember inverseOf familyMember,” as illustrated by relationships 454 and 456. Relationships 450-456 are illustrated using dashed arrows, which may indicate that the relationships were inferred as a result of applying mapping rules. Further, relationships 450-456 are directional, indicating directional relationships among resources 444-448. In some examples, given that a mutual “familyMember” relationship exists between resources 424 and 426, and resources 424 and 428, a single relationship having bidirectional arrow may be used rather than multiple relationships having unidirectional arrows.

Isolated collections 422 and 442 in FIGS. 4B and 4C, respectively, relate to the same underlying information in the isolated collection (e.g., isolated collection 402 in FIG. 4A) but, as a result of the application of one or more mapping rules, convey or represent this information differently. As a result, this information may conform with other information in different layers of the isolated collection (e.g., at different levels of a hierarchy) and may therefore be accessible or searchable based on pre-existing knowledge of the isolated collection. As an example, there may not be a widespread conception of a “hasSon” or “hasDaughter” relationship, but a “hasChild” or “familyMember” relationship may already exist, such that adapting isolated collection 402 to use such terminology makes the information contained within isolated collection 402 accessible when a query is performed using a “familyMember” relationship. As will be appreciated, while specific examples are discussed herein with respect to FIGS. 4A-4C, aspects of the present disclosure may be practiced with any type of information stored using any of a variety of techniques, such that information may be adapted in order to conform with conventions, attributes, or characteristics of other stored information.

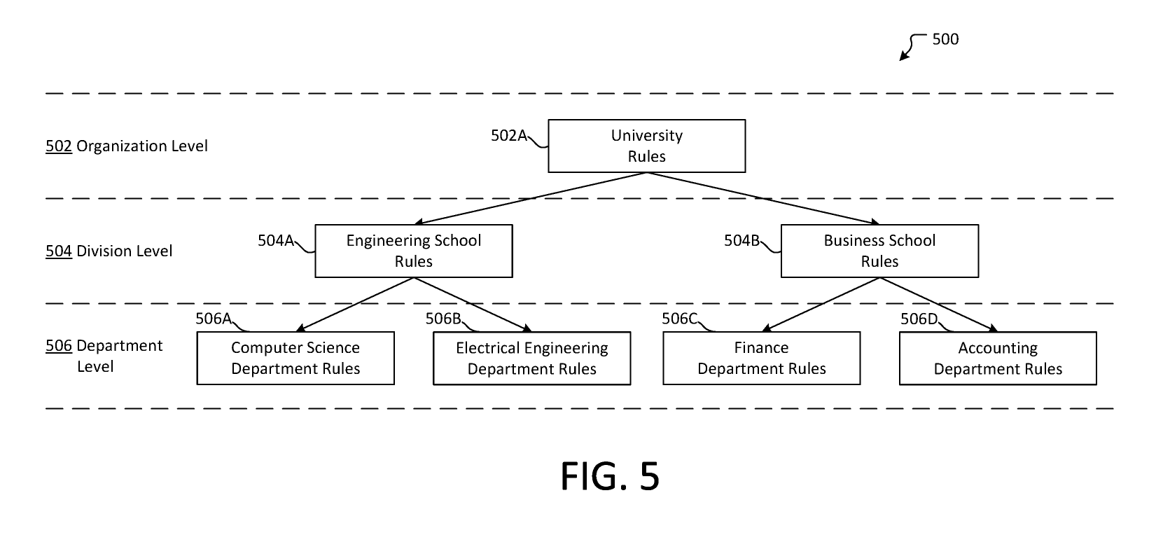

FIG. 5 illustrates an overview of an example rule hierarchy 500. Rule hierarchy 500 may be a rule hierarchy comprised of mapping rules associated with one or more isolated collections. As illustrated, rule hierarchy 500 is comprised of three levels: organization level 502, division level 504, and department level 506. As will be appreciated, while the instant example relates to a structure of a university, a hierarchy may relate to any of a variety of structures, including, but not limited to, a corporate structure, an employee organization chart, or one or more tenants in a multi-computing environment.

Each of the three levels of the rule hierarchy 500 may be associated with level-specific information in an isolated collection. For example, the isolated collection may comprise organization-specific information, division-specific information, and department-specific information. Accordingly, rules at organization level 502 (e.g., university rules 502A) may apply to information at or below the organization level, rules at division level 504 (e.g., engineering school rules 504A and business school rules 504B) may apply to information at or below the division level, and rules at department level 506 (e.g., computer science department rules 506A, electrical engineering department rules 506B, finance department rules 506C, and accounting department rules 506D) may apply to information at the department level. In an example, there may be one or more other levels that descend from at least one of rules 506A-506D.

Application of a mapping rule may follow the branched structure of rule hierarchy 500. As an example, information may be associated with the computer science department at department level 506 that is specific to the computer science department (e.g., it may have a specific structure, naming or organizational convention, etc.). As such, it may not conform to the structure, definitions, or other characteristics that are used at division level 504 (e.g., in the engineering school division). Accordingly, information associated with the computer science department may be adapted to the division level using one or more mapping rules from computer science department rules 506A. In another example, information associated with the electrical engineering department may be adapted to the division level using a mapping rule from electrical engineering department rules 506B, such that it may be further adapted using a mapping rule from at least one of engineering school rules 504A and/or university rules 502A. As such, once information is adapted to a level (e.g., adapting information associated with the computer science or electrical engineering departments to the engineering school division level), mapping rules that apply to that level (e.g., division level 504 and/or organization level 502) may be applied to the adapted information to further adapt the information.

In some examples, one or more mapping rules may be reused or adapted to a different level. As an example, finance department rules 506C may contain a mapping rule used to map information from the finance department level to division level 504. The mapping rule may be made available to other levels of the isolated collection, such that the mapping rule may be incorporated (e.g., reused, modified, etc.) into accounting department rules 506D and used to map information associated with the accounting department to division level 504. As will be appreciated, rules from other branches of the hierarchy (e.g., computer science department rules 506A, electrical engineering department rules 506B, etc.) and other levels (e.g., engineering rules 504A, business school rules 504B, etc.) may also be reused according to aspects disclosed herein.

When applying mapping rules from different levels 502-506 of the hierarchy, level-specific information may be adapted such that it conforms to the conventions, structure, or other characteristics of a different level. As an example, resource types, relationships, or other attributes or information may be adapted when applying a mapping rule. In some examples, adapting such information may comprise generating new information (e.g., resources, relationships, etc.) or omitting information based on the mapping rule. As a result, information at department level 506 associated with the computer science department may be adapted to division level 504 using one or more computer science department rules 506A. Similarly, information at department level 506 associated with the electrical engineering department may be adapted to division level 504 using one or more electrical engineering department rules 506B. As such, it may be possible to interact with information from both the computer science department and the electrical engineering department without having any department-level specific knowledge (e.g., about the organizational structure, the type of information associated with either department, etc.).

As discussed above, a mapping rule may be selected and evaluated to determine whether the mapping rule may be applied to information associated with a specific level of the hierarchy. In an example, a view may be generated for the information of the isolated collection based on the mapping rule, such that the adaptation of the information that is performed based on the mapping rule may be viewed and analyzed to determine whether the mapping rule may be applicable (e.g., in its current state, after modification, etc.) to the information. As a result, it may be possible to dynamically test or evaluate mapping rules (e.g., pre-existing mapping rules within rule hierarchy 500, a draft or other version of a mapping rule, etc.) within the isolated collection in order to select which one or more mapping rules should be applied when adapting the isolated collection.

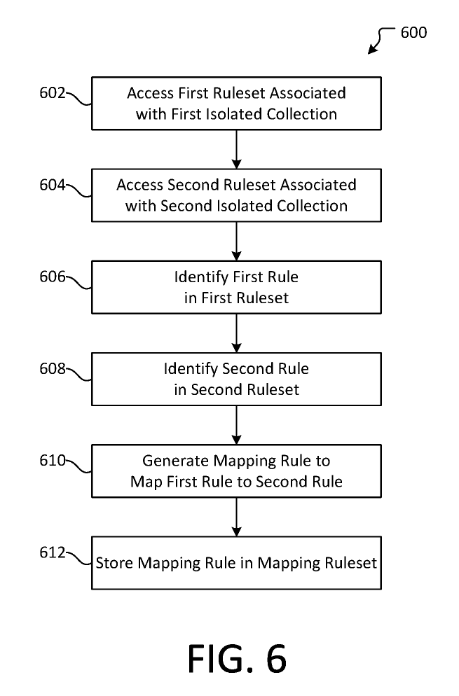

FIG. 6 illustrates an overview of an example method 600 for generating a mapping rule in a rule hierarchy. Method 600 may be performed by one or more computing devices, such as computing devices 102A-C in FIG. 1. Method 600 begins at operation 602, where a first ruleset associated with a first isolated collection may be accessed. In an example, the first ruleset may be a subpart of a larger ruleset or rule hierarchy (e.g., one of rules 502A, 504A-B, or 506A-D in FIG. 5). In another example, the first isolated collection may be a subpart of a larger isolated collection. The first ruleset and/or the first isolated collection may be associated with a level within a hierarchy as described herein. In some examples, the first isolated collection may comprise the first ruleset.

At operation 604, a second ruleset associated with a second isolated collection may be accessed. In some examples, the second ruleset may be a subpart of a larger ruleset or rule hierarchy (e.g., one of rules 502A, 504A-B, or 506A-D in FIG. 5). In another example, the first and second rulesets may be subparts of the same or different larger ruleset or rule hierarchy. In other examples, the second isolated collection may be a subpart of a larger isolated collection. In one example, the second isolated collection may be part of the same or a different larger isolated collection as the first isolated collection. The second isolated collection may be associated with a level (e.g., a similar or different level as the first isolated collection) within a hierarchy as described herein. In some examples, the second isolated collection may comprise the second ruleset.

Moving to operation 606, a first rule may be identified within the first ruleset. In an example, the first rule may be an asserted rule (e.g., relating to an asserted relationship, asserted resource, or other asserted information within the first isolated collection), an inference rule (e.g., relating to an inferred relationship, an inferred resource, or other inferred relationship within the first isolated collection), a mapping rule as described herein, or any other rule relating to information in the first isolated collection. Identifying the first rule may comprise selecting the rule from a list of one or more rules associated with the isolated collection, searching for and selecting a rule based on one or more criteria, or visually identifying information (e.g., a resource, relationship, etc.) within the first isolated collection to which the rule relates, among other selection techniques.

At operation 608, a second rule may be identified within the second ruleset. In an example, the second rule may be an asserted rule (e.g., relating to an asserted relationship, asserted resource, or other asserted information within the first isolated collection), an inference rule (e.g., relating to an inferred relationship, an inferred resource, or other inferred relationship within the first isolated collection), a mapping rule as described herein, or any other rule relating to information in the second isolated collection. Identifying the second rule may comprise selecting the rule from a list of one or more rules associated with the isolated collection, searching for and selecting a rule based on one or more criteria, or visually identifying information (e.g., a resource, relationship, etc.) within the second isolated collection to which the rule relates, among other selection techniques.

Moving to operation 610, a mapping rule may be generated to map the first rule to the second rule. Generating the mapping rule may comprise associating one or more components of the first rule with one or more components of the second rule (e.g., associating a “hasSon” relationship in the first isolated collection with a “hasChild” relationship in the second isolated collection, similar to the example illustrated in FIGS. 4A and 4B). In another example, the mapping rule may be generated based on the first rule and/or the second rule, such that similar information is captured as a result of applying the mapping rule, but in a manner that may not have been previously expressed by the first rule and/or the second rule. As an example, rather than mapping an “inverseOf” relationship of “parentIs inverseOf hasChild” using the mapping rule “parentIs mapsTo familyMember” as discussed above with respect to FIGS. 4A-4C, a new mapping rule may instead be generated to capture a similar relationship (e.g., “familyMember inverseOf familyMember,” as illustrated in FIG. 4C). As will be appreciated, generating the mapping rule may comprise associating at least a part of each of the first rule and the second rule with one another, modifying or revising a pre-existing rule (e.g., the first rule, the second rule, or another rule), or generating a new rule, among other techniques.

In an example, a mapping rule may be generated by examining two related resources in the first isolated collection and/or two related resources in the second isolated collection to determine information about a relationship between the resources. The examination may comprise examining the resources (e.g., information contained in or associated with the resources), metadata associated with the resources, or other information in order to determine a generic relationship for each of the pairs of resources. If the determined generic relationships are the same or similar between the first isolated collection and the second isolated collection, a mapping rule may be generated to map the rules associated with each of the resource pairs to one another. In another example, information about one or more relationships, resources, and/or rules for the first isolated collection and the second isolated collection may be analyzed in order to determine one or more mapping rules between each of the isolated collections. For example, it may be determined that a similar combination of rules is used in the first isolated collection as is used in the second isolated collection, such that one or more mapping rules may be generated to map the similarities between the isolated collections. In some examples, multiple resources and/or relationships may be analyzed within each of the first isolated collection and the second isolated collection in order to determine that a similar structure exists (e.g., a plurality of resources may be related in a similar structure between the two isolated collections, a similar combination of multiple relationships may exist between a plurality of resources, etc.). As a result of identifying the similar structure, one or more mapping rules may be generated in order to associate the structure identified in the first isolated collection with the structure identified in the second isolated collection.

At operation 612, the mapping rule may be stored in a mapping ruleset. In some examples, the mapping rule may be stored in a mapping ruleset that may be associated with or be part of the first ruleset and/or the second ruleset. In another example, the mapping rule and/or mapping ruleset may be associated with or stored in the first isolated collection and/or the second isolated collection. In other examples, the mapping rule may be stored in a mapping ruleset that is part of a rule hierarchy (e.g., rule hierarchy 500 in FIG. 5). As will be appreciated, the mapping rule may be stored using any of a variety of techniques and/or data stores, such that the mapping rule may be retrieved when accessing or performing processing with the isolated collection. Flow terminates at operation 612.

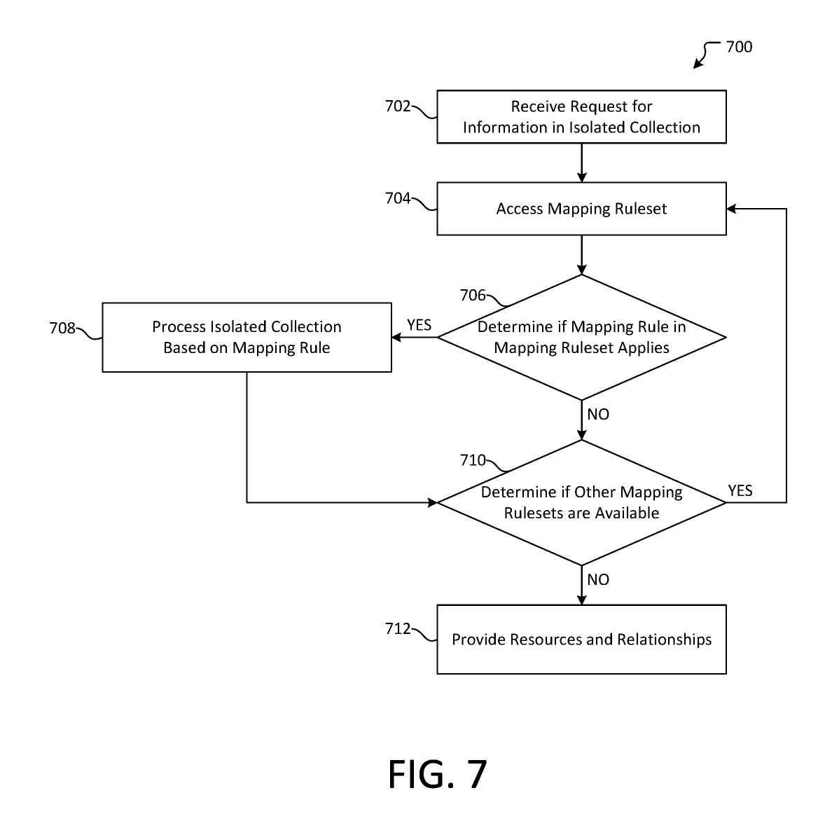

FIG. 7 illustrates an overview of an example method 700 for processing an isolated collection using a rule hierarchy. Method 700 may be performed by one or more computing devices, such as computing devices 102A-C in FIG. 1. In an example, method 700 may be performed in response to an access request for information in an isolated collection, including, but not limited to, a query for target information stored by the isolated collection, manipulating information in the isolated collection (e.g., adding, modifying, removing information, etc.), or any other operation relating to information stored by the isolated collection.

Method 700 begins at operation 702, where a request for information in an isolated collection may be received. The request may be received from a user or client of the isolated collection, from an application or service that stores, accesses, or uses information from the isolated collection among other requestors. In some examples, the request for information may relate to information stored by multiple isolated collections, or stored in an isolated collection that spans multiple computing devices, storage systems, and/or physical locations. In an example, the request may be for information associated with a specific level of a hierarchy (e.g., the engineering school at division level 504 or the computer science department at department level 506 in FIG. 5, a specific security clearance level, a division or team within a company, etc.).

Moving to operation 704, a mapping ruleset may be accessed. In some examples, the mapping ruleset may be a rule hierarchy (e.g., rule hierarchy 500 in FIG. 5), may be a subpart of rules in a rule hierarchy (e.g., rules 502A, 504A-B, and/or 506A-D in FIG. 5), or may be any other ruleset associated with the isolated collection. In other examples, the mapping ruleset may be associated with the specific level of the hierarchy to which the request relates. The association may be direct or indirect.

At decision operation 706, a determination may be made whether one or more mapping rules in the mapping ruleset apply. The determination may be based on whether the mapping rule is related to the request (e.g., whether the request relates to the same or similar information with which the mapping rule is associated, whether at least a portion of the mapping rule relates to the same information (e.g., a resource, relationship, property or attribute, etc.) as the request, etc.). In another example, the determination may be based on whether the mapping rule relates to information that is indirectly related to the request (e.g., the mapping rule relates to a similar domain of information, a similar relationship structure, or other similar attributes). As will be appreciated, any of a variety of techniques or evaluations may be used to determine whether a mapping rule applies to a request for information in an isolated collection.

If it is determined that one or more mapping rules in the mapping ruleset apply, flow branches “YES” to operation 708, where the isolated collection may be processed based on the mapping rules. In an example, processing the isolated collection may comprise accessing one or more resources and/or relationships to which a mapping rule applies and adapting the accessed information based on the mapping rule, such that the representation of the information in the isolated collection conforms with the mapping rule. In an example, the representation may be dynamically generated, such that the underlying resources and/or relationships remain unchanged and the mapping rule is applied on demand, or the representation may be cached or stored for later retrieval (e.g., in temporary storage, as another isolated collection, as additional resources or relationships in the isolated collection, etc.), among other techniques. Flow then progresses to operation 710, which will be discussed in further detail below.

If, however, it is determined that there are no mapping rules in the mapping ruleset that apply, flow branches “NO” to operation 710. At operation 710, a determination may be made whether other mapping rulesets are available. The determination may comprise evaluating other rules and/or rulesets within a rule hierarchy (e.g., rule hierarchy 500 in FIG. 5), in order to identify whether one or more other mapping rules are associated with or related to the information relating to the request. In another example, the determination may comprise traversing at least a portion of the rule hierarchy in order to identify one or more other rulesets that, as a result of the hierarchical structure, may apply (e.g., university rules 502A may also apply to one or more sub-levels, such as division level 504 and/or department level 506 in FIG. 5).

If it is determined that there are other rulesets available, flow branches “YES” to operation 704, where flow may loop between operations 704-710 while there are additional rulesets available. If, however, it is determined that there are no other rulesets available, flow branches “NO” to operation 712, where resources and relationships may be provided. In an example, providing the resources and relationships may comprise identifying information in the isolated collection relating to the request (e.g., based on evaluating a query, locating a resource having a specified identifier or other properties, etc.). In some examples, the resources and relationships may be provided or identified based on adapted information (e.g., as was adapted using mapping rules at operation 708 discussed above). As such, resources and/or relationships may be identified in the isolated collection based on adapted information as relating to the request, even though the underlying representation (e.g., the actual information stored in the isolated collection) may not, prior to the application of one or more mapping rules, relate to the request. In some examples, providing the resources and relationships may comprise generating and providing a result isolated collection containing such resources and relationships. In another example, resource identifiers or other metadata or location information may be provided in response to the request, thereby enabling a client to access the information from the isolated collection. The response may comprise information relating to one or more mapping rules that were applied to the isolated collection, such as the one or more mapping rules, a mapping table or other structure that may be applied to un-adapted underlying data to generate adapted data, among other information. As will be appreciated, the resources and relationships identified in response to the request may be processed or provided using any of a variety of techniques without departing from the spirit of this disclosure. Flow terminates at operation 712.

FIGS. 8-11 and the associated descriptions provide a discussion of a variety of operating environments in which aspects of the disclosure may be practiced. However, the devices and systems illustrated and discussed with respect to FIGS. 8-11 are for purposes of example and illustration and are not limiting of a vast number of computing device configurations that may be utilized for practicing aspects of the disclosure, described herein.

FIG. 8 is a block diagram illustrating physical components (e.g., hardware) of a computing device 800 with which aspects of the disclosure may be practiced. The computing device components described below may be suitable for the computing devices described above, including the client computing devices 102A-C and the server computing devices 106A-C. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 and one or more program modules 806 suitable for performing the various aspects disclosed herein such as a rule generation component 824 and a rule evaluation component 826. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., application 820) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

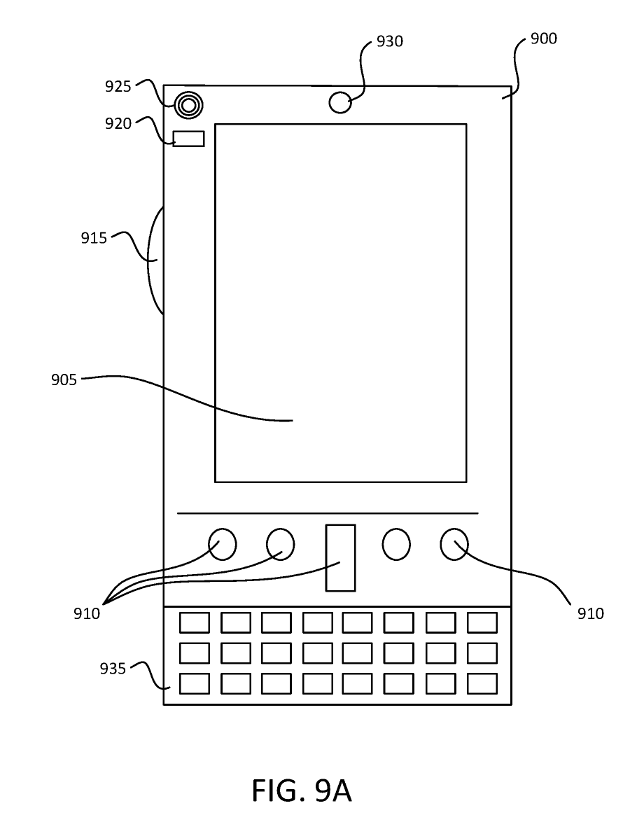

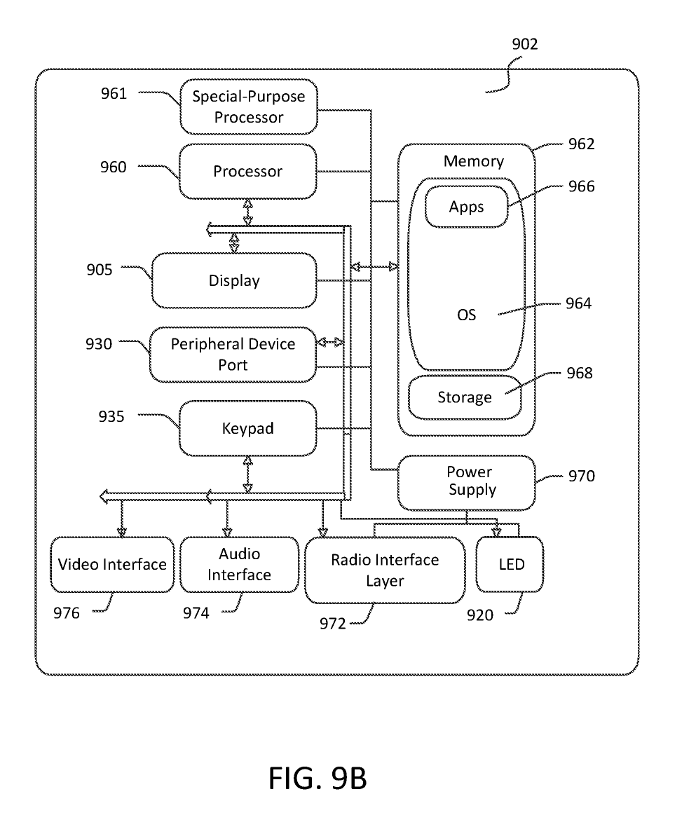

FIGS. 9A and 9B illustrate a mobile computing device 900, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 9A, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or less input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900 described herein (e.g., search engine, extractor module, relevancy ranking module, answer scoring module, etc.).

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated embodiment, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of an on-board camera 930 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

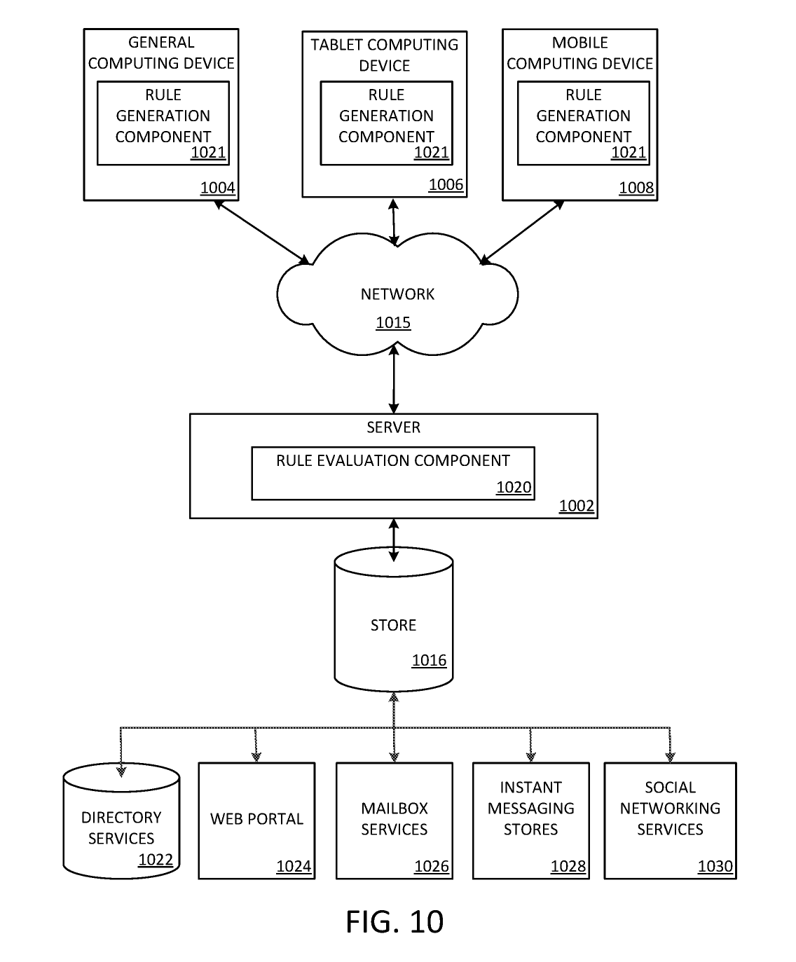

FIG. 10 illustrates one aspect of the architecture of a system for processing data received at a computing system from a remote source, such as a personal computer 1004, tablet computing device 1006, or mobile computing device 1008, as described above. Content displayed at server device 1002 may be stored in different communication channels or other storage types. For example, various documents may be stored using a directory service 1022, a web portal 1024, a mailbox service 1026, an instant messaging store 1028, or a social networking site 1030. Rule generation component 1021 may be employed by a client that communicates with server device 1002, and/or rule evaluation component 1020 may be employed by server device 1002. The server device 1002 may provide data to and from a client computing device such as a personal computer 1004, a tablet computing device 1006 and/or a mobile computing device 1008 (e.g., a smart phone) through a network 1015. By way of example, the computer system described above may be embodied in a personal computer 1004, a tablet computing device 1006 and/or a mobile computing device 1008 (e.g., a smart phone). Any of these embodiments of the computing devices may obtain content from the store 1016, in addition to receiving graphical data useable to be either pre-processed at a graphic-originating system, or post-processed at a receiving computing system.

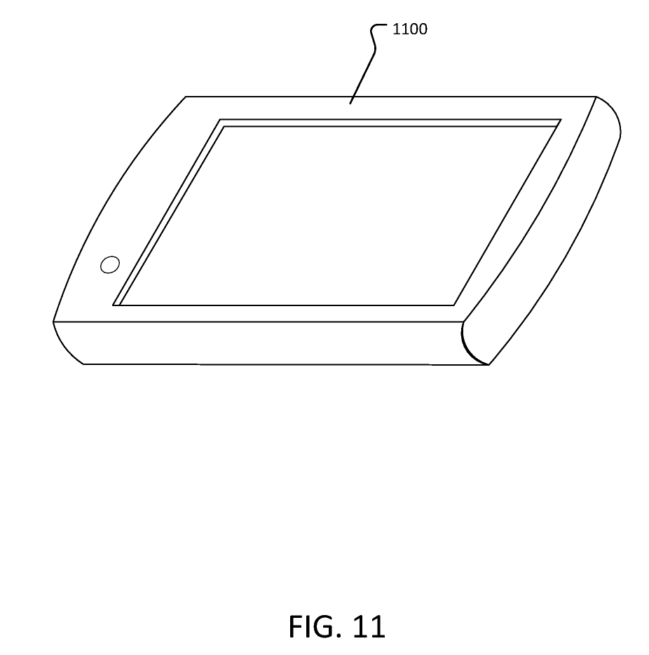

FIG. 11 illustrates an exemplary tablet computing device 1100 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and a memory storing instructions that when executed by the at least one processor perform a set of operations. The set of operations comprises: receiving a request for information in an isolated collection; identifying a ruleset associated with the isolated collection, wherein the ruleset comprises one or more mapping rules; generating, based on the one or more mapping rules, adapted information comprising at least a subpart of information from the isolated collection; generating, based on the adapted information, a response to the request for information; and providing the response in response to the request for information. In an example, identifying the ruleset comprises: determining a level of a hierarchy associated with one or more resources and relationships in the isolated collection; and selecting the ruleset from a rule hierarchy, wherein the ruleset is associated with the determined level of the hierarchy. In another example, generating the adapted information comprises: for each mapping rule of the one or more mapping rules: determining whether the mapping rule is associated with the one or more resources and relationships in the isolated collection; and when it is determined that the mapping rule is associated with the one or more resources and relationships, adapting at least one of the one or more resources and relationships based on the mapping rule. In a further example, generating the response to the request for information comprises evaluating at least a part of the isolated collection and the adapted information to identify one or more resources and relationships related to the request for information. In yet another example, identifying the ruleset comprises automatically selecting the ruleset based on a determination that at least one of the rules in the ruleset is related to the request. In a further still example, the set of operations further comprises: selecting a second ruleset from the rule hierarchy associated with a second level of the hierarchy; and generating, based on the second ruleset, second adapted information comprising at least a subpart of the adapted information. In an example, generating the response to the request comprises evaluating the second adapted information.

In another aspect, the technology relates to a computer-implemented method for generating a mapping rule to adapt information in an isolated collection. The method comprises: accessing a first ruleset associated with a first subpart of the isolated collection; accessing a second ruleset associated with a second subpart of the isolated collection; identifying a first rule of the first ruleset; identifying a second rule of the second ruleset; generating, based on the first rule and the second rule, a mapping rule to adapt information of the first subpart of the isolated collection to the second subpart of the isolated collection; and storing the mapping rule in a mapping ruleset associated with the isolated collection. In an example, the first subpart and the second subpart are associated with different levels of a hierarchy of the isolated collection. In another example, storing the mapping rule comprises making the mapping rule available to one or more clients of the isolated collection. In a further example, generating the mapping rule comprises: identifying a first subpart of the first rule; identifying a second subpart of the second rule; and generating, in the mapping rule, an association of the first subpart and the second subpart. In yet another example, generating the mapping rule comprises: evaluating a first plurality of resources and relationships of the first subpart of the isolated collection to determine a first relationship structure, wherein the first plurality of resources and relationships is associated with the first rule; evaluating a second plurality of resources and relationships of the second subpart of the isolated collection to determine a second relationship structure, wherein the second plurality of resources and relationships is associated with the second rule; determining, based on the first relationship structure and the second relationship structure, that a similar relationship structure exists in the first subpart of the isolated collection and the second subpart of the isolated collection; and generating the mapping rule to associate the first relationship structure and the second relationship structure. In a further still example, generating the mapping rule comprises: evaluating the first rule to determine a first generic relationship associated with the first rule; evaluating the second rule to determine a second generic relationship associated with the second rule; determining whether the first generic relationship and the second generic relationship describe a similar relationship within the first subpart of the isolated collection to the second subpart of the isolated collection; and when it is determined that the first generic relationship and the second generic relationship describe a similar relationship, generating, in the mapping rule, an association of the first rule and the second rule.

In another aspect, the technology relates to another computer-implemented method for adapting information of an isolated collection using a rule hierarchy. The method comprises: receiving a request for information in the isolated collection; identifying a ruleset associated with the isolated collection, wherein the ruleset comprises one or more mapping rules; generating, based on the one or more mapping rules, adapted information comprising at least a subpart of information from the isolated collection; generating, based on the adapted information, a response to the request for information; and providing the response in response to the request for information. In an example, identifying the ruleset comprises: determining a level of a hierarchy associated with one or more resources and relationships in the isolated collection; and selecting the ruleset from a rule hierarchy, wherein the ruleset is associated with the determined level of the hierarchy. In another example, generating the adapted information comprises: for each mapping rule of the one or more mapping rules: determining whether the mapping rule is associated with the one or more resources and relationships in the isolated collection; and when it is determined that the mapping rule is associated with the one or more resources and relationships, adapting at least one of the one or more resources and relationships based on the mapping rule. In a further example, generating the response to the request for information comprises evaluating at least a part of the isolated collection and the adapted information to identify one or more resources and relationships related to the request for information. In yet another example, identifying the ruleset comprises automatically selecting the ruleset based on a determination that at least one of the rules in the ruleset is related to the request. In a further still example, the method further comprises: selecting a second ruleset from the rule hierarchy associated with a second level of the hierarchy; and generating, based on the second ruleset, second adapted information comprising at least a subpart of the adapted information. In an example, generating the response to the request comprises evaluating the second adapted information.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
a memory storing instructions that when executed by the at least one processor perform a set of operations comprising:
receiving a request for information in an isolated collection;
identifying a ruleset associated with the isolated collection, wherein the ruleset comprises one or more mapping rules;
generating, based on the one or more mapping rules, adapted information comprising at least a subpart of information from the isolated collection;
generating, based on the adapted information, a response to the request for information; and
providing the response in response to the request for information.

2. The system of claim 1, wherein identifying the ruleset comprises:
determining a level of a hierarchy associated with one or more resources and relationships in the isolated collection; and
selecting the ruleset from a rule hierarchy, wherein the ruleset is associated with the determined level of the hierarchy.

3. The system of claim 2, wherein generating the adapted information comprises:
for each mapping rule of the one or more mapping rules:
determining whether the mapping rule is associated with the one or more resources and relationships in the isolated collection; and
when it is determined that the mapping rule is associated with the one or more resources and relationships, adapting at least one of the one or more resources and relationships based on the mapping rule.

4. The system of claim 1, wherein generating the response to the request for information comprises evaluating at least a part of the isolated collection and the adapted information to identify one or more resources and relationships related to the request for information.

5. The system of claim 1, wherein identifying the ruleset comprises automatically selecting the ruleset based on a determination that at least one of the rules in the ruleset is related to the request.

6. The system of claim 2, wherein the set of operations further comprises:
selecting a second ruleset from the rule hierarchy associated with a second level of the hierarchy; and
generating, based on the second ruleset, second adapted information comprising at least a subpart of the adapted information.

7. The system of claim 6, wherein generating the response to the request comprises evaluating the second adapted information.

8. A computer-implemented method for generating a mapping rule to adapt information in an isolated collection, the method comprising:
accessing a first ruleset associated with a first subpart of the isolated collection;
accessing a second ruleset associated with a second subpart of the isolated collection;
identifying a first rule of the first ruleset;
identifying a second rule of the second ruleset;
generating, based on the first rule and the second rule, a mapping rule to adapt information of the first subpart of the isolated collection to the second subpart of the isolated collection; and
storing the mapping rule in a mapping ruleset associated with the isolated collection.

9. The computer-implemented method of claim 8, wherein the first subpart and the second subpart are associated with different levels of a hierarchy of the isolated collection.

10. The computer-implemented method of claim 8, wherein storing the mapping rule comprises making the mapping rule available to one or more clients of the isolated collection.

11. The computer-implemented method of claim 8, wherein generating the mapping rule comprises:
identifying a first subpart of the first rule;
identifying a second subpart of the second rule; and
generating, in the mapping rule, an association of the first subpart and the second subpart.

12. The computer-implemented method of claim 8, wherein generating the mapping rule comprises:
evaluating a first plurality of resources and relationships of the first subpart of the isolated collection to determine a first relationship structure, wherein the first plurality of resources and relationships is associated with the first rule;
evaluating a second plurality of resources and relationships of the second subpart of the isolated collection to determine a second relationship structure, wherein the second plurality of resources and relationships is associated with the second rule;
determining, based on the first relationship structure and the second relationship structure, that a similar relationship structure exists in the first subpart of the isolated collection and the second subpart of the isolated collection; and
generating the mapping rule to associate the first relationship structure and the second relationship structure.

13. The computer-implemented method of claim 8, wherein generating the mapping rule comprises:
evaluating the first rule to determine a first generic relationship associated with the first rule;
evaluating the second rule to determine a second generic relationship associated with the second rule;
determining whether the first generic relationship and the second generic relationship describe a similar relationship within the first subpart of the isolated collection to the second subpart of the isolated collection; and
when it is determined that the first generic relationship and the second generic relationship describe a similar relationship, generating, in the mapping rule, an association of the first rule and the second rule.

14. A computer-implemented method for adapting information of an isolated collection using a rule hierarchy, the method comprising:
receiving a request for information in the isolated collection;
identifying a ruleset associated with the isolated collection, wherein the ruleset comprises one or more mapping rules;
generating, based on the one or more mapping rules, adapted information comprising at least a subpart of information from the isolated collection;
generating, based on the adapted information, a response to the request for information; and
providing the response in response to the request for information.

15. The computer-implemented method of claim 14, wherein identifying the ruleset comprises:
determining a level of a hierarchy associated with one or more resources and relationships in the isolated collection; and
selecting the ruleset from a rule hierarchy, wherein the ruleset is associated with the determined level of the hierarchy.

16. The computer-implemented method of claim 15, wherein generating the adapted information comprises:
for each mapping rule of the one or more mapping rules:
determining whether the mapping rule is associated with the one or more resources and relationships in the isolated collection; and
when it is determined that the mapping rule is associated with the one or more resources and relationships, adapting at least one of the one or more resources and relationships based on the mapping rule.

17. The computer-implemented method of claim 14, wherein generating the response to the request for information comprises evaluating at least a part of the isolated collection and the adapted information to identify one or more resources and relationships related to the request for information.

18. The computer-implemented method of claim 14, wherein identifying the ruleset comprises automatically selecting the ruleset based on a determination that at least one of the rules in the ruleset is related to the request.

19. The computer-implemented method of claim 15, further comprising:
selecting a second ruleset from the rule hierarchy associated with a second level of the hierarchy; and
generating, based on the second ruleset, second adapted information comprising at least a subpart of the adapted information.

20. The computer-implemented method of claim 19, wherein generating the response to the request comprises evaluating the second adapted information.
